(19) United States
(12) Patent Application Publication
(10) Pub. No.: US 2026/0042316 A1
(43) Pub. Date: Feb. 12, 2026

(54) OMNI WHEEL AND VEHICLE

(71) Applicant: WISTRON CORP., New Taipei City (TW)

(72) Inventors: Chen-Yi LIANG, New Taipei City (TW); Cheng Hsing Liu, New Taipei City (TW)

(21) Appl. No.: 18/964,597

(22) Filed: Dec. 1, 2024

(30) Foreign Application Priority Data
Aug. 7, 2024 (TW) 113129544

(51) Int. Cl. B60B 19/00

(52) U.S. Cl. CPC B60B 19/003

(57) ABSTRACT

An omni wheel including a hub and a roller assembly. The hub includes a disk assembly. The roller assembly includes a plurality of rollers. The plurality of rollers are disposed on the disk assembly. The plurality of rollers each comprise a wider portion and a narrower portion connected to a side of the wider portion so that a step is formed between the wider portion and the narrower portion.

### CROSS-REFERENCE TO RELATED APPLICATIONS

This non-provisional application claims priority under 35 U.S. C. § 119(a) on Patent Application No(s). 113129544 filed in Taiwan, R.O.C. on August 7th, 2024, the entire contents of which are hereby incorporated by reference.

### TECHNICAL FIELD

The disclosure relates to a wheel, more particularly to an omni wheel and a vehicle including the same.

### BACKGROUND

In general, an omni wheel includes a hub and multiple rollers. The rollers are rotatably disposed on multiple mounting protrusions radially protruding outwards from the hub via pivots.

However, in order to prevent the rotation of the rollers from being disturbed by the interference between the rollers and the mounting protrusions, the adjacent rollers are spaced apart from each other by a certain amount of distance. Accordingly, the movement of the omni wheel along a forward direction or backward direction is unstable.

### SUMMARY

The disclosure provides an omni wheel and a vehicle whose roller includes a wider portion and a narrower portion that form a step therebetween, thereby allowing the movement of the omni wheel along a forward direction or a backward direction to be stable by shortening the distance between adjacent rollers.

One embodiment of this disclosure provides an omni wheel including a hub and a roller assembly. The hub includes a disk assembly. The roller assembly includes a plurality of rollers. The plurality of rollers are disposed on the disk assembly. The plurality of rollers each comprise a wider portion and a narrower portion connected to a side of the wider portion so that a step is formed between the wider portion and the narrower portion.

Another embodiment of this disclosure provides a vehicle including a vehicle body and an omni wheel. The omni wheel is disposed on the vehicle body and includes a hub and a roller assembly. The hub includes a disk assembly. The roller assembly includes a plurality of rollers. The plurality of rollers are disposed on the disk assembly. The plurality of rollers each comprise a wider portion and a narrower portion connected to a side of the wider portion so that a step is formed between the wider portion and the narrower portion.

According to the omni wheel disclosed by above embodiments, a step is formed between the wider portion and the narrower portion in each roller. That is, two side parts of the roller are in a step shape and each have a notch or a recess. Thus, the roller is allowed to have larger diameter without reducing structural strength and without being interfered with the disk assembly or another roller. In this way, the roller is allowed to laterally climb a higher step. In addition, with the notch or the recess on the roller, not only the interference between the said roller and the disk assembly or another roller is prevented, but also the possibility for the disk assembly to be impacted during the lateral movement of the omni wheel is reduced.

Additionally, with such step design, the amount of the material for manufacturing the roller is reduced without reducing the diameter of the roller, thereby reducing the manufacture cost of the omni wheel.

Also, the size of the disk assembly is increased without adjusting the distance between the peripherally adjacent rollers, thereby enhancing the structural strength of the disk assembly.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an omni wheel according to a first embodiment of the disclosure;

FIG. 2 is an exploded view of the omni wheel in FIG. 1;

FIG. 3 is a side view of a roller of the omni wheel in FIG. 1;

FIG. 4 is a partially enlarged side view of the omni wheel in FIG. 1;

FIG. 5 is a top view of the omni wheel in FIG. 1;

FIG. 6 is a side view of a roller according to a second embodiment of the disclosure;

FIG. 7 is an exploded view of an omni wheel according to a third embodiment of the disclosure;

FIG. 8 is a top view of the omni wheel in FIG. 7;

FIG. 9 is a side view of a roller according to a fourth embodiment of the disclosure;

FIG. 10 is a side view of a roller according to a fifth embodiment of the disclosure;

FIG. 11 is a partially enlarged side view of an omni wheel according to a sixth embodiment of the disclosure;

FIG. 12 is a side view of a roller of the omni wheel in FIG. 11;

FIG. 13 is a partially enlarged side view of an omni wheel according to a seventh embodiment of the disclosure;

FIG. 14 is a top view of the omni wheel in FIG. 13; and

FIG. 15 is a schematic plan view of a vehicle according to an eighth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

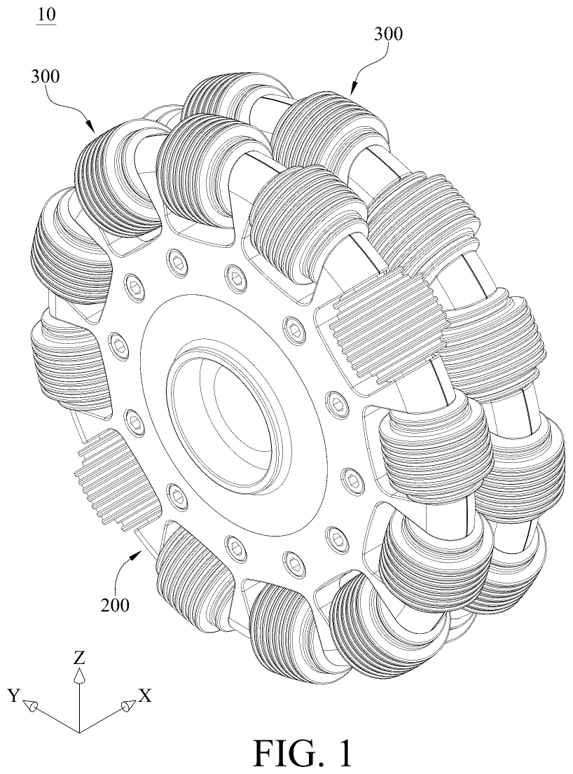

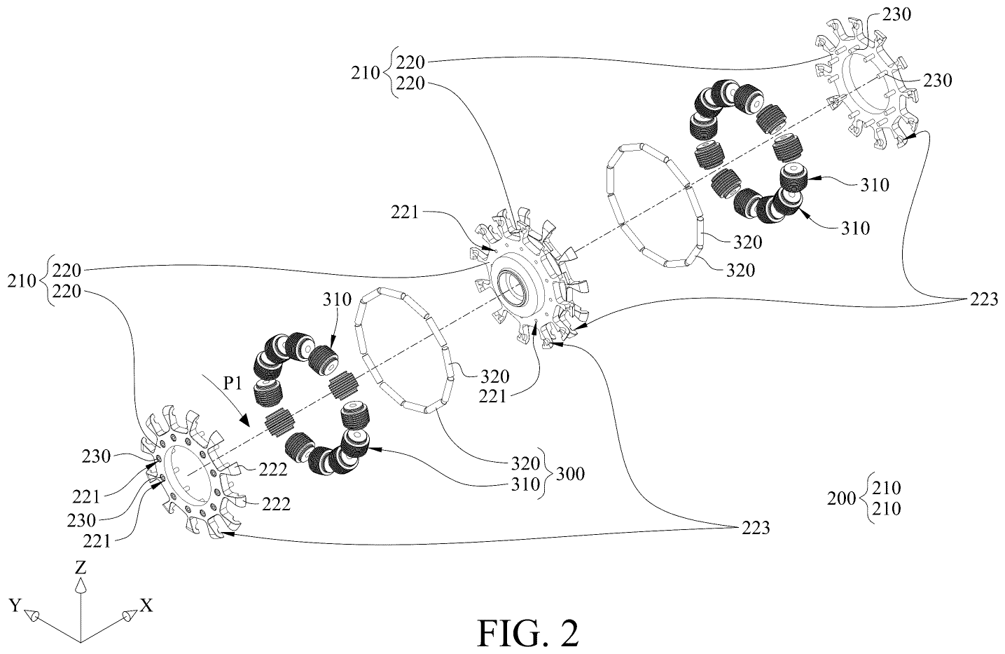

Please refer to FIGS. 1 and 2. FIG. 1 is a perspective view of an omni wheel 10 according to a first embodiment of the disclosure. FIG. 2 is an exploded view of the omni wheel 10 in FIG. 1. In this embodiment, the omni wheel 10 includes, for example, a hub 200 and two roller assemblies 300. Note that the omni wheel 10 of this disclosure may be applied to, for example, any type of device that is moved with the help of one or more rollers, such as a wheel chair, a cart, and a conveyor.

In this embodiment, the hub 200 includes, for example, two disk assemblies 210. Since the two disk assemblies 210 and the two roller assemblies 300 have similar structures, one disk assembly 210 and one roller assembly 300 that are corresponding to each other will be exemplarily described in detail hereinafter.

In this embodiment, the disk assembly 210 includes, for example, two mounting plates 220, and the omni wheel 10 may further include a plurality of positioning components 230. The two mounting plates 220 are in, for example, a disk shape. Each mounting plate 220 has a plurality of positioning holes 221. The positioning components 230 are disposed through the positioning holes 221 of the two mounting plates 220, respectively, so as to fix the two mounting plates 220 to each other. With the positioning components 230, the two mounting plates 220 are allowed to be assembled or disassembled in a convenient manner, and the shear strength of the disk assembly 210 is enhanced. In other embodiments, the disk assembly may include one positioning component or may not include the positioning component.

One mounting plate 220 of one disk assembly 210 may be adjacent and assembled to another mounting plate 220 of another disk assembly 210. Note that, the disk assembly 210 is not limited to including two mounting plates 220 that are fixed to each other. In other embodiments, the two mounting plates of the same disk assembly may be integrally formed as a single piece.

As shown in FIG. 2, in this embodiment, the mounting plate 220 has, for example, a plurality of mounting protrusions 222 radially protruding outwards therefrom. The mounting protrusions 222 are arranged along a peripheral direction P1 of the mounting plate 220. The mounting protrusions 222 of one mounting plate 220 form a plurality of pivot holes 223 together with the mounting protrusions 222 of another mounting plate 220, respectively.

In this embodiment, the roller assembly 300 includes a plurality of rollers 310 and a plurality of pivots 320. The pivots 320 are rotatably disposed in the pivot holes 223, respectively, so as to allow the rollers 310 to be rotatably disposed on the mounting protrusions 222 of the mounting plate 220 via the pivots 320, respectively. Moreover, the rollers 310 are arranged along the peripheral direction P1. Note that in other embodiments, if the rollers are in the form of ball rollers, the roller assembly may not include the pivots 320.

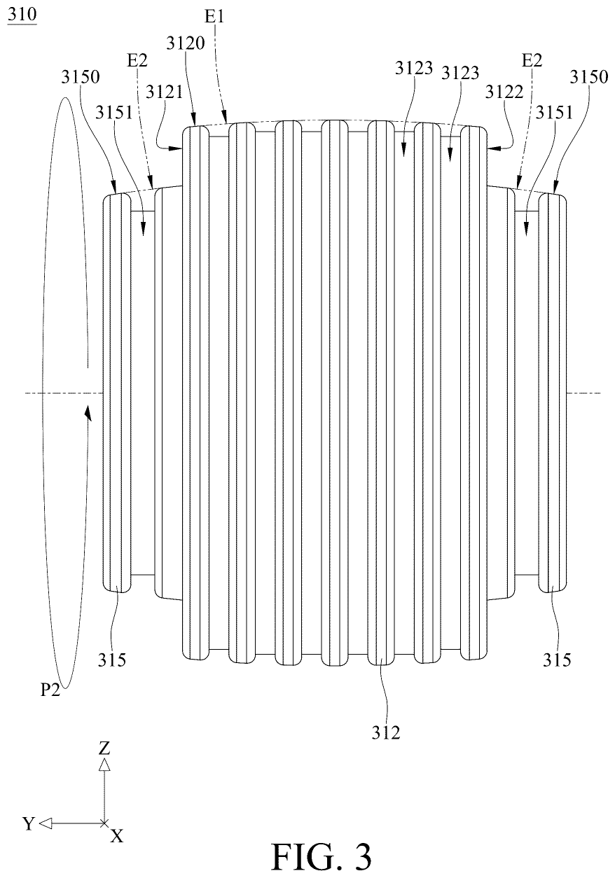

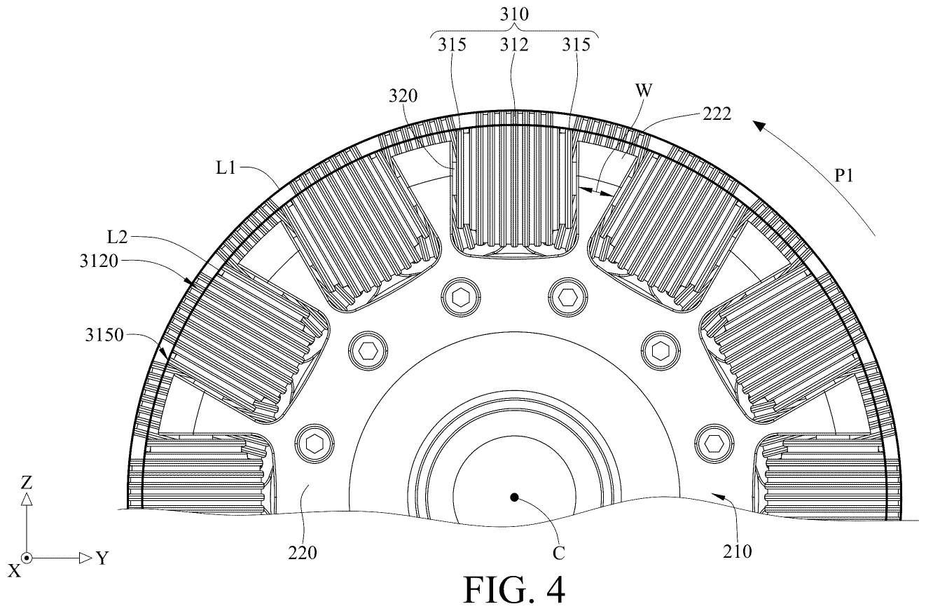

Please refer to FIGS. 3 and 4. FIG. 3 is a side view of the roller 310 of the omni wheel 10 in FIG. 1. FIG. 4 is a partially enlarged side view of the omni wheel 10 in FIG. 1. In this embodiment, each roller 310 includes a wider portion 312 and two narrower portions 315. The two narrower portions 315 are connected to two opposite sides of the wider portion 312, respectively, so that two steps are formed between the two narrower portions 315 and the wider portion 312. In other words, two side parts of the roller 310 are in a step shape and each have a notch or a recess. In this disclosure, the step is formed by, for example, a straight edge of the narrower portion 315 and a straight edge of the wider portion 312 that are adjacent to each other. Note that in this or other embodiments, the step may be formed by at least one straight edge of the narrower portion 315 or the wider portion 312; that is, the step is not totally formed by an arc edge.

Specifically, as shown in FIG. 4, with such step design of the roller 310, a width W of the mounting protrusions 222 along the peripheral direction P1 is increased from a side thereof connected to the mounting plate 220 to a side thereof located away from the mounting plate 220. That is, with the step formed on the roller 310, the roller 310 has the notch or the recess, and the mounting protrusions 222 radially taper toward the mounting plate 220. Accordingly, the roller 310 is allowed to have larger diameter without reducing structural strength and without being interfered with the disk assembly 210 or another roller 310. In this way, the roller 310 is allowed to laterally climb a higher step (e.g., climb a higher step by rotating along Y-axis direction or by moving along X-axis direction). Furthermore, with the notch or the recess on the roller 310, not only the interference between the said roller 310 and the disk assembly 210 or another roller 310 is prevented, but also the possibility for the disk assembly 210 to be impacted during the lateral movement of the omni wheel 10 is reduced.

Additionally, with such step design, the amount of the material for manufacturing the roller 310 is reduced without reducing the diameter of the roller 310, thereby reducing the manufacture cost of the omni wheel 10. Also, the size of the disk assembly 210 is increased (e.g., the width of an inner part of the mounting protrusion 222 is increased) without adjusting the distance between the peripherally adjacent rollers 310, thereby enhancing the structural strength of the disk assembly 210.

In addition, as shown in FIG. 3, in this embodiment, the wider portion 312 has a wider peripheral surface 3120, a first side surface 3121, a second side surface 3122 and a plurality of first straight groove 3123. The wider peripheral surface 3120 is, for example, an outer surface. The first side surface 3121 and the second side surface 3122 are connected to two opposite sides of the wider peripheral surface 3120, respectively. The first straight groove 3123 radially recesses inwards from the wider peripheral surface 3120, and is configured to enhance the friction generated between the roller 310 and a supporting surface (e.g., ground surface) supporting the roller 310. The two narrower portions 315 protrude from the first side surface 3121 and the second side surface 3122, respectively. Also, an extension direction of the first straight groove 3123 is, for example, parallel to a peripheral direction P2 of the roller 310.

Each narrower portion 315 has a narrower peripheral surface 3150 and a second straight groove 3151. The narrower peripheral surface 3150 is, for example, an outer surface. The second straight groove 3151 radially recesses inwards from the narrower peripheral surface 3150, and is configured to enhance the friction generated between the roller 310 and the supporting surface. In addition, an extension direction of the second straight groove 3151 is, for example, parallel to the peripheral direction P2 of the roller 310. For example, the first side surface 3121 and the second side surface 3122 of the wider portion 312 form the said two steps together with the two narrower peripheral surfaces 3150 of the two narrower portions 315, respectively.

The first straight groove 3123 and the second straight groove 3151 are configured to enhance the friction generated between the roller 310 and the supporting surface. In other embodiments, the wider portion and the narrower portion may not have the first straight groove and the second straight groove, and the friction generated between the roller and the surface supporting the roller may be enhanced by adjusting the type of the material forming the roller. Note that in this embodiment or other embodiments, the first straight groove 3123 and the second straight groove 3151 may have the same axial width (e.g., width along Y-axis direction) or different axial widths.

Moreover, as shown in FIG. 4, in this embodiment, a part of the narrower portion 315 of the roller 310 is radially located outside the mounting protrusion 222. Thus, the possibility for the mounting protrusion 222 to be impacted by the supporting surface is reduced, thereby allowing the omni wheel 10 to rotate in a smoother manner.

In addition, as shown in FIGS. 3 and 4, in this embodiment, the wider peripheral surface 3120 and the narrower peripheral surface 3150 are in, for example, an arc shape, and thus the vibration generated during the rotation of the roller 310 is reduced. Also, a circular outline L1 formed by the wider peripheral surface 3120 and a circular outline L2 formed by the narrower peripheral surface 3150 are concentric. A reference plane whose normal direction is parallel to the axial direction of the mounting plate 220 and perpendicular to the axial direction of the pivot 320 (i.e., the reference plane is parallel to YZ plane) is defined, and the pivot 320 is located on the reference plane. The feature that the circular outline L1 formed by the wider peripheral surface 3120 and the circular outline L2 formed by the narrower peripheral surface 3150 are concentric is mentioned above. It may be understood that such feature denotes that on the reference plane, both of a center of an arc edge E1 (represented by two-dot chain line in FIG. 3) of the wider peripheral surface 3120 located away from the central axis C of the mounting plate 220 and a center of an arc edge E2 (represented by two-dot chain line in FIG. 3) of the narrower peripheral surface 3150 located away from the central axis C are located on the central axis C (parallel to X-axis).

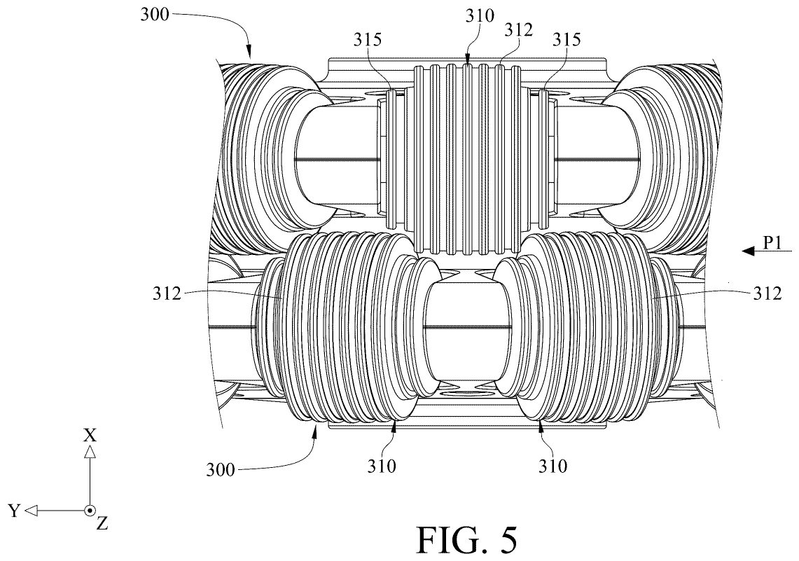

Please refer to FIG. 5 that is a top view of the omni wheel 10 in FIG. 1. In this embodiment, the wider portions 312 of the rollers 310 of adjacent two roller assemblies 300 are partially overlapped along the peripheral direction P1. In other words, one roller 310 of one roller assembly 300 is partially located between two wider portions 312 of adjacent two rollers 310 of another adjacent roller assembly 300 along the peripheral direction P1. In still other words, in this embodiment, in a space between two wider portions 312 of adjacent two rollers 310 (being adjacent along the peripheral direction P1) of one roller assembly 300, a part of the wider portion 312 of one roller 310 of another roller assembly 300 (being adjacent to the one roller assembly 300 along X-axis direction) and the two narrower portions 315 of adjacent two rollers 310 of the one roller assembly 300 are accommodated. Thus, the radial thickness (i.e., the thickness along a direction perpendicular to the peripheral direction P1) of the wider portion 312 is allowed to be increased without increasing the overall axial thickness (i.e., the thickness along X-axis direction) of the omni wheel 10, thereby enhancing the buffer effect of the roller 310 and reducing the noise generated during the rotation of the roller 310. Alternatively, the volume of the narrower portion 315 is allowed to be reduced without reducing the axial thickness of the wider portion 312, thereby reducing the overall axial thickness of the omni wheel 10 by making the adjacent roller assembly 300 to be closer. Alternatively, the diameter of the roller 310 is allowed to be increased without increasing the overall outer diameter of the omni wheel 10, thereby allowing the omni wheel 10 to laterally climb a higher step (e.g., climb a higher step by rotating along Y-axis direction or by moving along X-axis direction). Also, the rollers 310 of different roller assemblies 300 sequentially contact the supporting surface to improve the continuity of the rotation of the omni wheel 10, thereby improving the stability of the rotation of the omni wheel 10. Moreover, peripherally adjacent rollers 310 of the adjacent roller assemblies 300 are allowed to be spaced part from each other by a shorter distance. Thus, the movement of omni wheel 10 along the forward direction or the backward direction is stable, and the possibility for a foreign material to enter into the space between adjacent rollers 310 is reduced.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

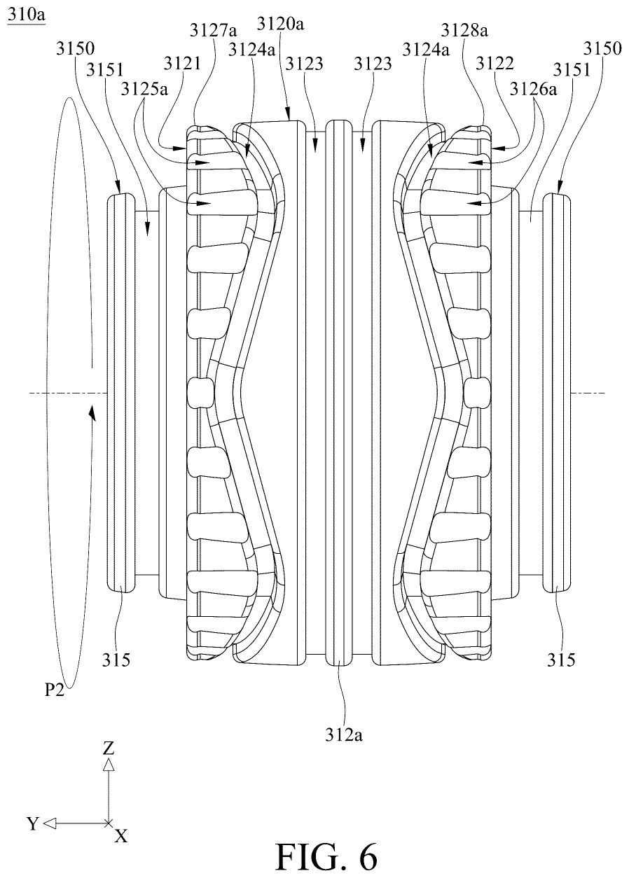

Please refer to FIG. 6 that is a side view of a roller 310a according to a second embodiment of the disclosure. The difference between the roller 310a of this embodiment and the roller 310 of the first embodiment is in that a wider portion 312a of the roller 310a of this embodiment further has two inclined grooves 3124a, a plurality of first recesses 3125a, a plurality of second recesses 3126a, a first protrusion 3127a and a second protrusion 3128a.

The two inclined grooves 3124a radially recess inwards from the wider peripheral surface 3120a, and are configured to enhance the friction generated between the roller 310a and the supporting surface. An extension direction of the two inclined groove 3124a is non-parallel to the peripheral direction P2 of the roller 310a. The first straight groove 3123 is located between the two inclined grooves 3124a. During the rotation of the roller 310a, a lateral force is generated at the inclined groove 3124a along Y-axis direction. Thus, the friction generated at the first straight groove 3123 is reduced, thereby prolonging the lifespan of the roller 310a by reducing the abrasion of the wider portion 312a during rotation. That is, since no lateral force is generated at the first straight groove 3123 during the rotation of the roller 310a, the time period for the first straight groove 3123 to be in contact with the supporting surface is long. Also, the first straight groove 3123 is located on a thickest part of the roller 310a. Thus, with the inclined grooves 3124a that allow the lateral force to be generated thereat, the lifespan of the roller 310a may be prolonged.

The first recesses 3125a and the second recesses 3126a radially recess inwards from the wider peripheral surface 3120a. The first recesses 3125a are arranged along the peripheral direction P2 of the roller 310a, and are located on a position where the wider peripheral surface 3120a and the first side surface 3121 are connected. The second recesses 3126a are arranged along the peripheral direction P2 of the roller 310a, and are located on a position where the wider peripheral surface 3120a and the second side surface 3122 are connected. With the first recesses 3125a and the second recesses 3126a, the vibration and the noise generated during the rotation of the omni wheel including the roller 310a are further reduced.

The first protrusion 3127a and the second protrusion 3128a radially protrude from the wider peripheral surface 3120a. The first protrusion 3127a is located on a position where the wider peripheral surface 3120a and the first side surface 3121 are connected. The second protrusion 3128a is located on a position where the wider peripheral surface 3120a and the second side surface 3122 are connected. The first recesses 3125a and the second recesses 3126a are located on, for example, the first protrusion 3127a and the second protrusion 3128a, respectively. During the rotation of the roller 310a, the first protrusion 3127a and the second protrusion 3128a that radially protruding from the wider peripheral surface 3120a contact the supporting surface before the wider peripheral surface 3120a contacts the supporting surface. Thus, the stability of the rotation of the roller 310a is further improved, and the lifespan of the roller 310a is further prolonged by reducing the abrasion of the wider peripheral surface 3120a.

Note that the wider portion 312a is not limited to having all of the two inclined grooves 3124a, the recesses (i.e., the first recesses 3125a and the second recesses 3126a) and the protrusions (i.e., the first protrusion 3127a and the second protrusion 3128a). In other embodiments, the wider portion may have at least one of the inclined grooves, the recesses and the protrusions.

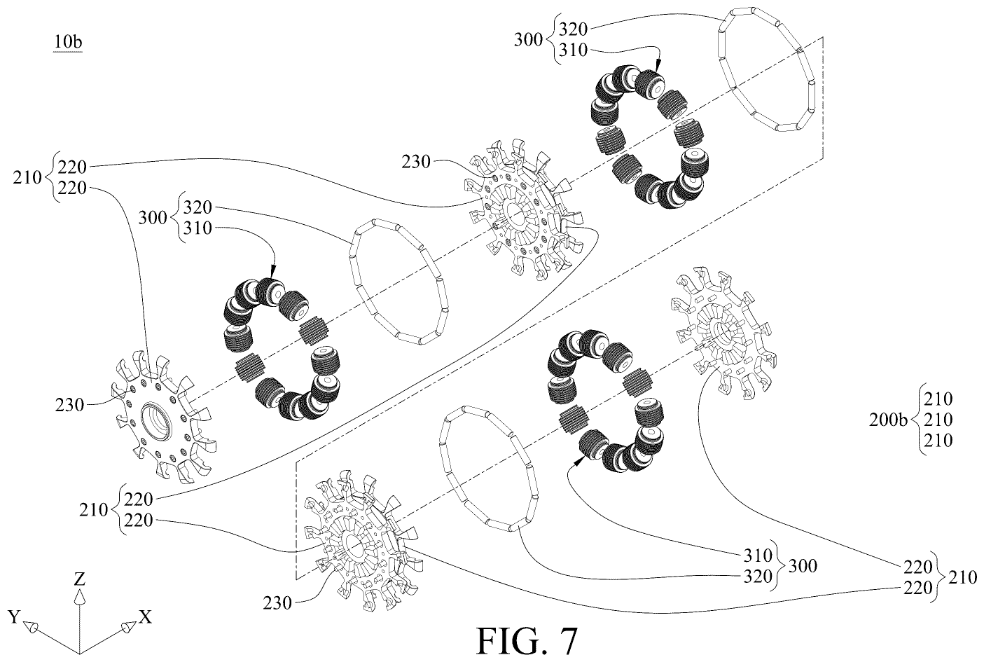

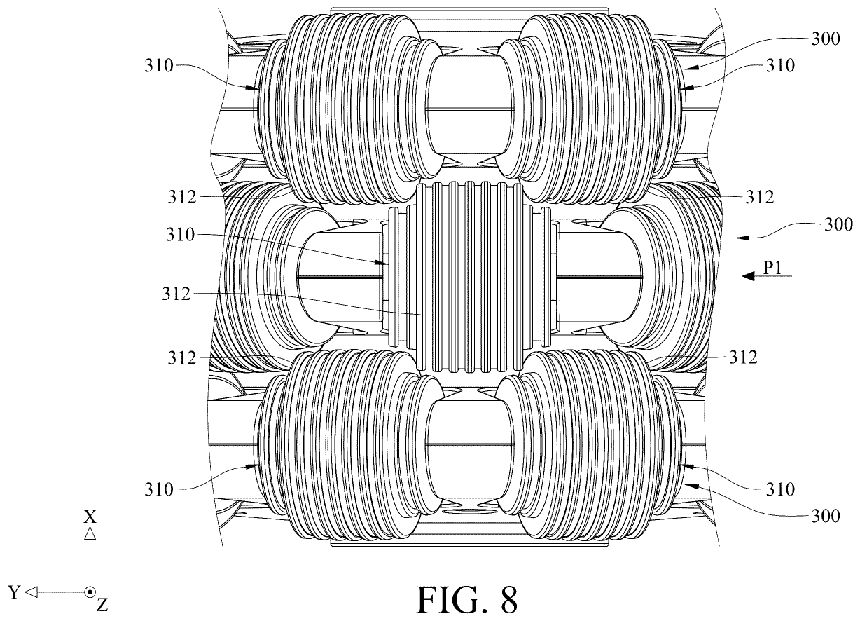

Further, the disclosure is not limited by the number of the roller assemblies and the number of the disk assemblies. Please refer to FIGS. 7 and 8. FIG. 7 is an exploded view of an omni wheel 10b according to a third embodiment of the disclosure. FIG. 8 is a top view of the omni wheel 10b in FIG. 7. In this embodiment, the omni wheel 10b includes, for example, one hub 200b and three roller assemblies 300. The hub 200b includes, for example, three disk assemblies 210. Similarly, the wider portions 312 of the rollers 310 of the adjacent two roller assemblies 300 are partially overlapped along the peripheral direction P1. By increasing the number of the roller assemblies 300, the stability of the rotation of the omni wheel 10b is further improved.

It is understood that in other embodiments, the omni wheel may include one roller assembly, and the hub may include one disk assembly; alternatively, in still other embodiments, the omni wheel may include four or more roller assembly, and the hub may include four or more disk assembly as long as the number of the roller assembly is equal to the number of the disk assembly.

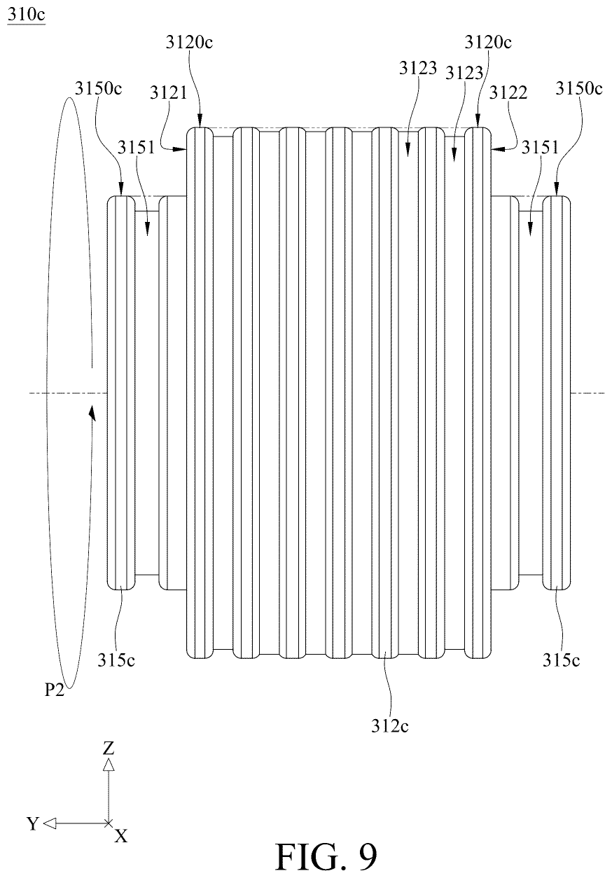

The disclosure is not limited by the shape of the wider peripheral surface and the shape of the narrower peripheral surface. The wider peripheral surface and the narrower peripheral surface may partially or entirely be flat to reduce the manufacture cost of the roller. For example, please refer to FIG. 9 that is a side view of a roller 310c according to a fourth embodiment of the disclosure. The difference between the roller 310c of this embodiment and the roller 310 of the first embodiment is in the shape of a wider peripheral surface 3120c and the shape of a narrower peripheral surface 3150c. In this embodiment, the wider peripheral surface 3120c and the narrower peripheral surface 3150c are entirely in, for example, a flat shape.

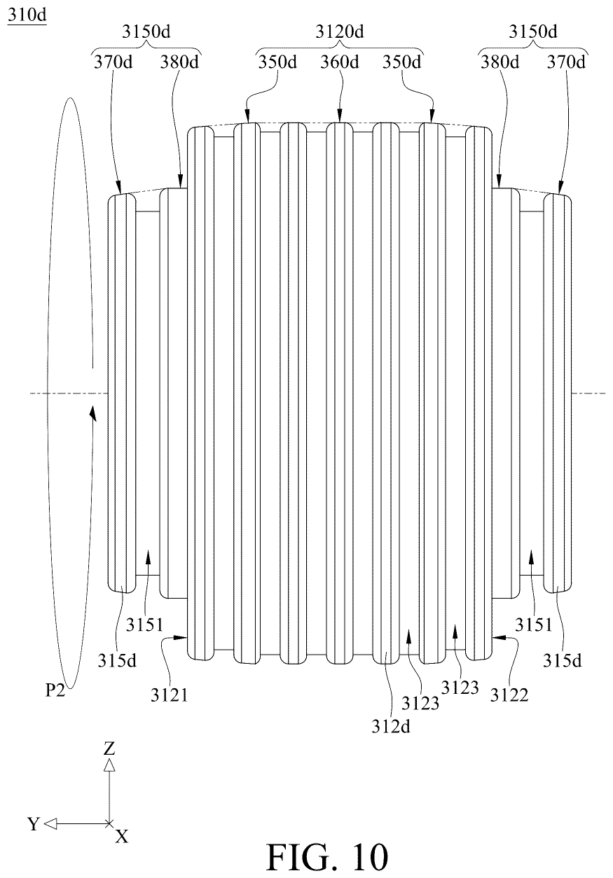

Alternatively, please refer to FIG. 10 that is a side view of a roller 310d according to a fifth embodiment of the disclosure. The difference between the roller 310d of this embodiment and the roller 310 of the first embodiment is in the shape of a wider peripheral surface 3120d and the shape of a narrower peripheral surface 3150d. In this embodiment, the wider peripheral surface 3120d includes a flat portion 360d and two arc portions 350d. The two arc portions 350d are connected to two opposite sides of the flat portion 360d, respectively. In addition, each narrower peripheral surface 3150d includes a flat portion 380d and an arc portion 370d connected to each other.

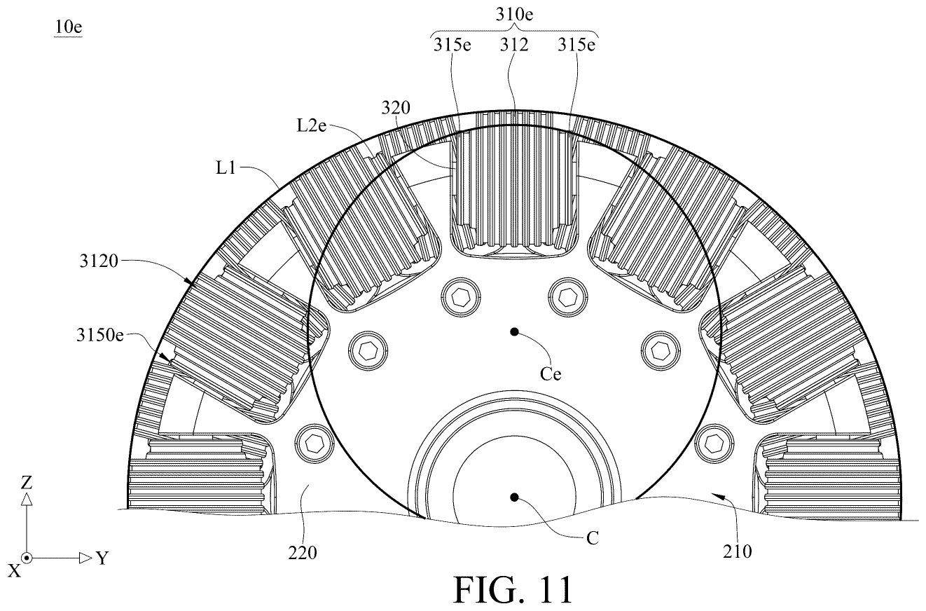

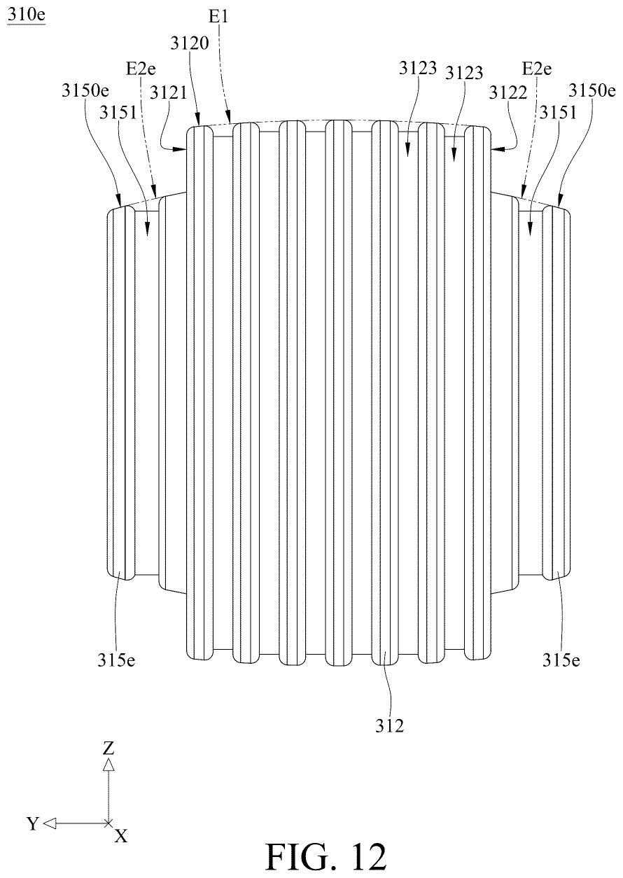

Furthermore, the disclosure is not limited to the outline of the roller. Please refer to FIGS. 11 and 12. FIG. 11 is a partially enlarged side view of an omni wheel 10e according to a sixth embodiment of the disclosure. FIG. 12 is a side view of a roller 310e of the omni wheel 10e in FIG. 11.

The difference between the omni wheel 10e of this embodiment and the omni wheel 10 of the first embodiment is in the outline of the narrower peripheral surface 3150e. In this embodiment, the circular outline L1 formed by the wider peripheral surface 3120 of the roller 310e and a circular outline L2e formed by a narrower peripheral surface 3150e are not concentric. A reference plane whose normal direction is parallel to the axial direction of the mounting plate 220 and perpendicular to the axial direction of the pivot 320 (i.e., the reference plane is parallel to YZ plane) is defined, and the pivot 320 is located on the reference plane. The feature that the circular outline L1 formed by the wider peripheral surface 3120 and the circular outline L2e formed by the narrower peripheral surface 3150e are not concentric is mentioned above. It may be understood that such feature denotes that on the reference plane, the center of the arc edge E1 of the wider peripheral surface 3120 located away from the central axis C is located on the central axis C (parallel to X-axis), but a center of an arc edge E2e of the narrower peripheral surface 3150e located away from the central axis C is spaced apart from the central axis C.

Note that the roller 310a of the second embodiment, the roller 310c of the fourth embodiment and the roller 310d of the fifth embodiment may be included in an omni wheel. That is, the roller 310 in the omni wheel 10 of the first embodiment may be replaced by the roller 310a of the second embodiment, the roller 310c of the fourth embodiment or the roller 310d of the fifth embodiment.

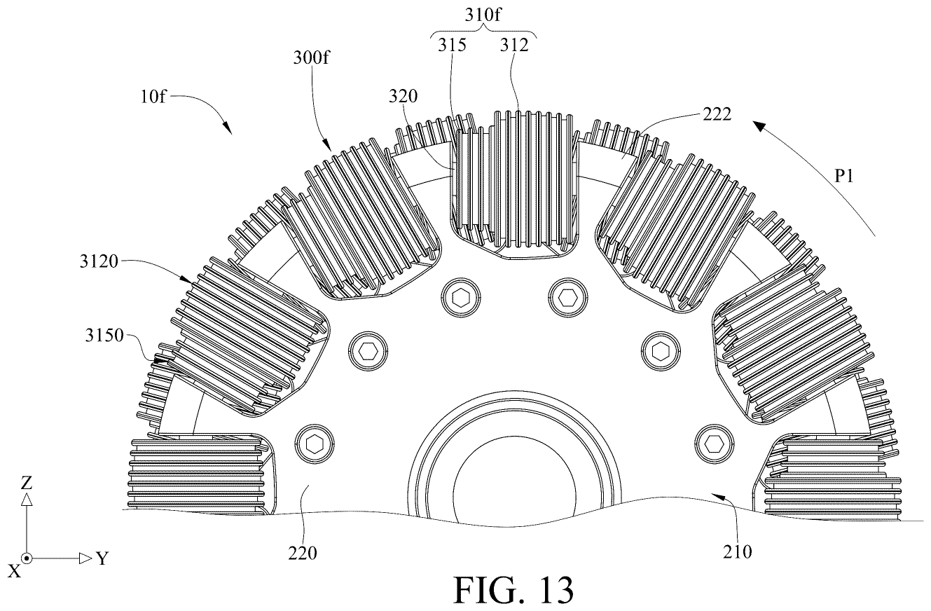

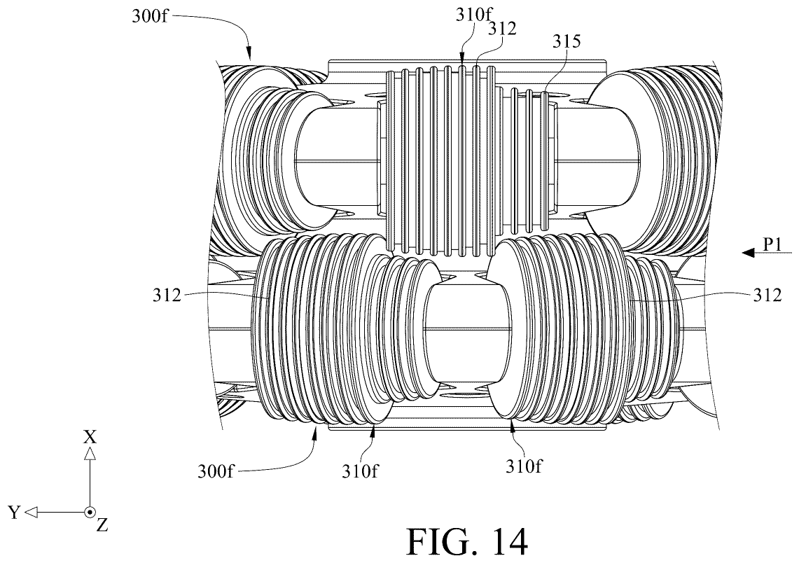

The disclosure is not limited by the number of the narrower portion. Please refer to FIGS. 13 and 14. FIG. 13 is a partially enlarged side view of an omni wheel 10f according to a seventh embodiment of the disclosure. FIG. 14 is a top view of the omni wheel 10f in FIG. 13. The difference between the omni wheel 10f of this embodiment and the omni wheel 10 of the first embodiment is in that a roller 310f of a roller assembly 300f of the omni wheel 10f include one wider portion 312 and one narrower portion 315. The narrower portion 315 is connected to a side of the wider portion 312. The rollers 310f are rotatably disposed on the mounting protrusion 222 of the mounting plate 220 via the pivots 320, respectively. Also, as shown in FIG. 14, the wider portions 312 of the rollers 310f of adjacent two roller assemblies 300f are partially overlapped along the peripheral direction P1. That is, in this embodiment, in a space between two wider portions 312 of adjacent two rollers 310f (being adjacent along the peripheral direction P1) of one roller assembly 300f, a part of the wider portion 312 of one roller 310f of another roller assembly 300f (being adjacent to the one roller assembly 300f along X-axis direction) and one narrower portion 315 of one of adjacent two rollers 310 of the one roller assembly 300 are accommodated.

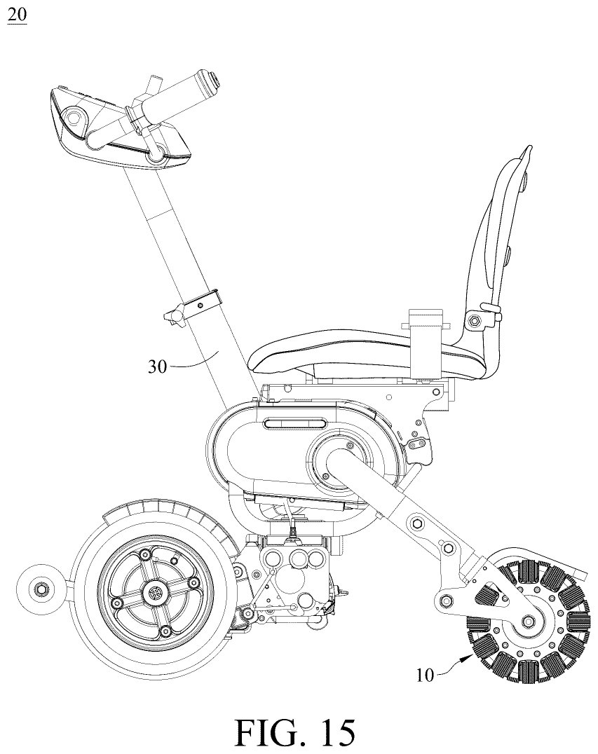

Please refer to FIG. 15 that is a schematic plan view of a vehicle 20 according to an eighth embodiment of the disclosure. The vehicle 20 is, for example, a mobility aid, and includes a vehicle body 30 and the omni wheel 10 of the first embodiment. The omni wheel 10 is disposed on the vehicle body 30. Note that the omni wheels 10b, 10e and 10f of other embodiments and the rollers 310a, 310c and 310d of other embodiments may be applied to the vehicle 20.

According to the omni wheel disclosed by above embodiments, a step is formed between the wider portion and the narrower portion in each roller. That is, two side parts of the roller are in a step shape and each have a notch or a recess. Thus, the roller is allowed to have larger diameter without reducing structural strength and without being interfered with the disk assembly or another roller. In this way, the roller is allowed to laterally climb a higher step. In addition, with the notch or the recess on the roller, not only the interference between the said roller and the disk assembly or another roller is prevented, but also the possibility for the disk assembly to be impacted during the lateral movement of the omni wheel is reduced.

Additionally, with such step design, the amount of the material for manufacturing the roller is reduced without reducing the diameter of the roller, thereby reducing the manufacture cost of the omni wheel.

Also, the size of the disk assembly is increased without adjusting the distance between the peripherally adjacent rollers, thereby enhancing the structural strength of the disk assembly.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An omni wheel, comprising:
a hub, comprising a disk assembly; and
a roller assembly, comprising a plurality of rollers; and
wherein, the plurality of rollers are disposed on the disk assembly, the plurality of rollers each comprise a wider portion and a narrower portion connected to a side of the wider portion so that a step is formed between the wider portion and the narrower portion.

2. The omni wheel according to claim 1, wherein the roller assembly further comprises a plurality of pivots, and the plurality of rollers are rotatably disposed on the disk assembly via the plurality of pivots, respectively.

3. The omni wheel according to claim 2, wherein the roller assembly comprises a plurality of roller assemblies, the disk assembly comprises a plurality of disk assemblies, the plurality of pivots of the plurality of roller assembly are rotatably disposed on the plurality of disk assemblies, respectively, the wider portions of the plurality of rollers of two adjacent ones of the plurality of roller assemblies are partially overlapped along a peripheral direction of the plurality of disk assemblies.

4. The omni wheel according to claim 2, wherein the disk assembly comprises two mounting plates, the two mounting plates are fixed to each other and together form a plurality of pivot holes, and the plurality of pivots of the roller assembly are rotatably disposed in the plurality of pivot holes, respectively.

5. The omni wheel according to claim 4, wherein the two mounting plates each have a plurality of mounting protrusions radially protruding outwards therefrom, the plurality of mounting protrusions are arranged along a peripheral direction of the disk assembly, the plurality of mounting protrusions radially taper toward the disk assembly, and the plurality of mounting protrusion of one of the two mounting plates forms the plurality of pivot holes together with the plurality of mounting protrusions of another one of the two mounting plate, respectively.

6. The omni wheel according to claim 5, wherein the narrower portion of each of the plurality of rollers is radially located outside the plurality of mounting protrusions.

7. The omni wheel according to claim 4, further comprising a positioning component disposed through the two mounting plates.

8. The omni wheel according to claim 1, wherein the wider portion of each of the plurality of rollers has a first straight groove, in each of the plurality of rollers, the first straight groove radially recesses inwards, and an extension direction of the first straight groove is parallel to a peripheral direction of the roller.

9. The omni wheel according to claim 8, wherein the narrower portion of each of the plurality of rollers has a second straight groove, in each of the plurality of rollers, the second straight groove radially recesses inwards, and an extension direction of the second straight groove is parallel to the peripheral direction of the roller.

10. The omni wheel according to claim 8, wherein the wider portion of each of the plurality of rollers has two inclined grooves, in each of the plurality of rollers, the two inclined grooves radially recess inwards, an extension direction of the two inclined grooves is non-parallel to the peripheral direction of the roller, and the first straight groove is located between the two inclined groove.

11. The omni wheel according to claim 1, wherein the wider portion of each of the plurality of rollers has a wider peripheral surface that is in an arc shape, and the narrower portion of each of the plurality of rollers has a narrower peripheral surface that is in an arc shape.

12. The omni wheel according to claim 11, wherein a circular outline formed by the wider peripheral surface of the wider portion of each of the plurality of rollers and a circular outline formed by the narrower peripheral surface of the narrower portion of each of the plurality of rollers are concentric.

13. The omni wheel according to claim 11, wherein a circular outline formed by the wider peripheral surface of the wider portion of each of the plurality of rollers and a circular outline formed by the narrower peripheral surface of the narrower portion of each of the plurality of rollers are not concentric.

14. The omni wheel according to claim 1, wherein the wider portion of each of the plurality of rollers has a wider peripheral surface that is in a flat shape.

15. The omni wheel according to claim 1, wherein the wider portion of each of the plurality of rollers has a wider peripheral surface comprising a flat portion and two arc portions, and the two arc portions are connected to two opposite sides of the flat portion, respectively.

16. The omni wheel according to claim 1, wherein the wider portion of each of the plurality of rollers has a wider peripheral surface, a first side surface, a second side surface, a first protrusion and a second protrusion, in each of the plurality of rollers, the first side surface and the second side surface are connected to two opposite sides of the wider peripheral surface, respectively, the narrower portion protrudes from one of the first side surface and the second side surface, the first protrusion and the second protrusion radially protrude from the wider peripheral surface, the first protrusion is located on a position where the wider peripheral surface and the first side surface are connected, and the second protrusion is located on a position where the wider peripheral surface and the second side surface are connected.

17. The omni wheel according to claim 1, wherein the wider portion of each of the plurality of rollers has a wider peripheral surface, a first side surface, a second side surface, a plurality of first recesses and a plurality of second recesses, in each of the plurality of rollers, the first side surface and the second side surface are connected to two opposite sides of the wider peripheral surface, respectively, the narrower portion protrudes from one of the first side surface and the second side surface, the plurality of first recesses and the plurality of second recesses radially recess inwards from the wider peripheral surface, the plurality of first recesses are arranged along a peripheral direction of the roller, and are located on a position where the wider peripheral surface and the first side surface are connected, and the plurality of second recesses re arranged along the peripheral direction of the roller, and are located on a position where the wider peripheral surface and the second side surface are connected.

18. The omni wheel according to claim 1, wherein the narrower portion of each of the plurality of rollers comprises two narrower portions, in each of the plurality of rollers, the two narrower portions are connected to two opposite sides of the wider portion, respectively, so that two steps are formed between the two narrower portions and the wider portion.

19. The omni wheel according to claim 1, wherein the plurality of rollers are arranged along a peripheral direction of the disk assembly.

20. A vehicle, comprising:
a vehicle body; and
an omni wheel, disposed on the vehicle body and comprising:
a hub, comprising a disk assembly; and
a roller assembly, comprising a plurality of rollers; and
wherein, the plurality of rollers are disposed on the disk assembly, the plurality of rollers each comprise a wider portion and a narrower portion connected to a side of the wider portion so that a step is formed between the wider portion and narrower portion.
